(19) United States
(12) Patent Application Publication
(10) Pub. No.: US 2016/0350713 A1
(43) Pub. Date: Dec. 1, 2016

(54) DELIVERY ADDRESS POSITIONING SYSTEM BASED ON INTERNET OF VEHICLES AND DELIVERY ADDRESS POSITIONING METHOD USING SAME

(71) Applicant: HON HAI PRECISION INDUSTRY CO., LTD., New Taipei (TW)

(72) Inventors: SHU-KAN NIEH, New Taipei (TW); HUI-HSUAN CHOU, New Taipei (TW); KUANG-YAO LIAO, New Taipei (TW); HSIEN-HOU CHEN, New Taipei (TW)

(21) Appl. No.: 14/821,257

(22) Filed: Aug. 7, 2015

(30) Foreign Application Priority Data
May 28, 2015 (TW) 104117103

(51) Int. Cl. G06Q 10/08; H04W 4/02; H04W 60/00; H04W 4/14

(52) U.S. Cl. CPC G06Q 10/0835; H04W 4/14; H04W 4/02; H04W 60/00

(57) ABSTRACT

A delivery address positioning method based on Internet of vehicles is provided. The method includes the steps as follows. Control a timing unit of the smart device to start timing when a real-time speed of the smart device is zero. Obtain a position information of the smart device from a GPS unit of the smart device and a registration information stored by a storage unit of the smart device when a time period timed by the timing unit is greater than a predefined time period. Transmit the position information and the registration information to the server. Search a database of the server according to the registration information. Determine whether the database includes at least one order matches with the registration information. And deliver the position information to a logistics center when the database includes at least one order matches with the registration information.

### FIELD

The subject matter herein generally relates to delivery address positioning systems, based on Internet of vehicles, especially to a delivery address positioning system based on Internet of vehicles and a delivery address positioning method using same which can help a courier to deliver goods quickly.

### BACKGROUND

In this busy society, more and more people are prefer to online shopping. The goods shopped online can be delivered via Logistics.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an operating environment of a delivery address positioning system based on Internet of vehicles.

FIG. 2 is a block diagram of an embodiment of the delivery address positioning system based on Internet of vehicles.

FIGS. 3 and 4 cooperatively constitute a single flowchart of an embodiment of a delivery address positioning method based on Internet of vehicles.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure relates to a delivery address positioning system based on Internet of vehicles, which is running on a smart device and a server. The delivery address positioning system includes at least one processing unit and a non-transitory computer readable medium coupled to the at least one processing unit and configured to store instructions for execution by the at least one processing unit. The instructions cause the at least one processing unit to control a timing unit of the smart device to start timing when a real-time speed of the smart device is zero. The instructions cause the at least one processing unit to obtain a position information of the smart device from a global positioning system (GPS) unit of the smart device and a registration information stored by a storage unit of the smart device when a time period timed by the timing unit is greater than a predefined time period. The instructions cause the at least one processing unit to transmit the position information and the registration information to the server. The instructions cause the at least one processing unit to search a database of the server according to the registration information; determine whether the database includes at least one order matches with the registration information. The instructions cause the at least one processing unit to deliver, when the database includes at least one order matches with the registration information, the position information to a logistics center.

The present disclosure relates to a delivery address positioning method based on Internet of vehicles, which is running on a smart device and a server. The delivery address positioning method includes as follows. Controlling a timing unit of the smart device to start timing when a real-time speed of the smart device is zero. Obtaining a position information of the smart device from a GPS unit of the smart device and a registration information stored by a storage unit of the smart device when a time period timed by the timing unit is greater than a predefined time period. Transmitting the position information and the registration information to the server. Searching a database of the server according to the registration information; determining whether the database includes at least one order matches with the registration information. And delivering the position information to a logistics center when the database includes at least one order matches with the registration information.

The present disclosure relates to a non-transitory storage medium having stored thereon instructions that, when executed by at least one processing unit of a smart device and a server, cause the at least one processing unit to execute instructions of a delivery address positioning method. The delivery address positioning method includes as follows. Controlling a timing unit of the smart device to start timing when a real-time speed of the smart device is zero. Obtaining a position information of the smart device from a GPS unit of the smart device and a registration information stored by a storage unit of the smart device when a time period timed by the timing unit is greater than a predefined time period. Transmitting the position information and the registration information to the server. Searching a database of the server according to the registration information. Determining whether the database includes at least one order matches with the registration information. And delivering the position information to a logistics center when the database includes at least one order matches with the registration information.

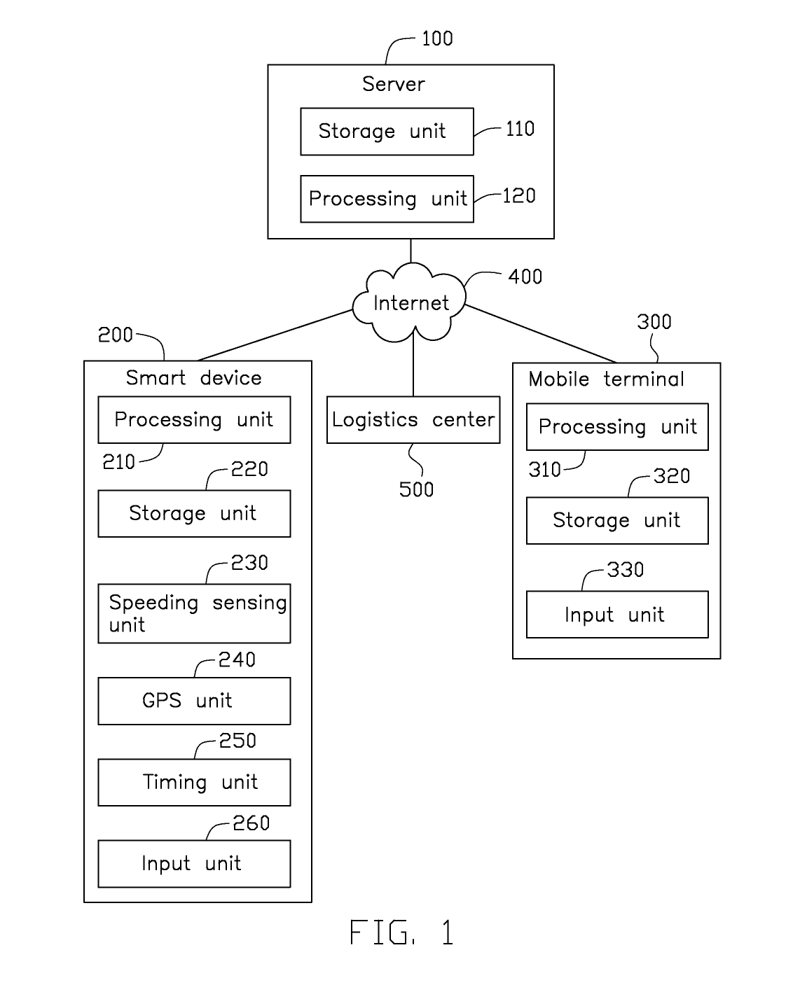

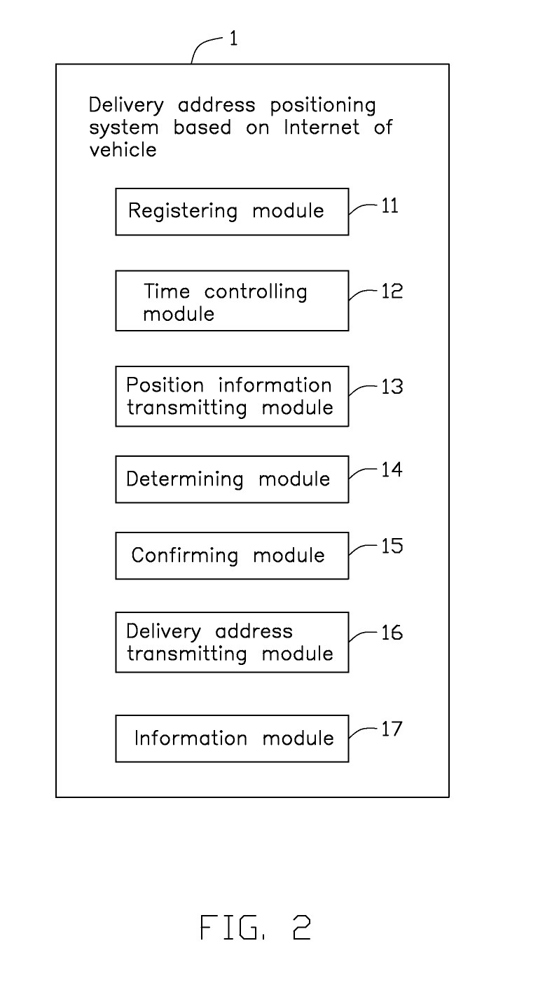

FIG. 1 shows an embodiment of an operating environment of a delivery address positioning system based on Internet of vehicles as shown in FIG. 2. The Internet of vehicles is a huge interactive network constituted by vehicle positions, vehicle speeds, route information or the like. The vehicle can collect information including their own environment and status through GPS, RFID, sensors, cameras and/or image processing device. All collected information can be brought together to a central processing unit through Internet technology. These information can be then analyzed and processed to calculate best routes of different vehicles, road conditions and arrangements for cycle lights or the like.

The operating environment can include but not limited to a server 100, a smart device 200 and a mobile terminal 300. The smart device 200 can be mounted on a vehicle. The smart device 200 can communicate with the server 100 via an Internet 400. The server 100 can communicate with the mobile terminal 300 via the Internet 400. The server 100 can further communicate with a logistics center 500 via the Internet 400. The logistics center 500 can include database at least including delivery information of each order, and further update the database in real time.

The smart device 200 can be an intelligent terminal mounted on the vehicle. The vehicle can be coupled to the Internet of vehicles via the smart device 200. The smart device 200 can move synchronously with the vehicle, that is, the real-time speed and the real-time position of the vehicle can be detected via the smart device 200.

The mobile terminal 300 can be but not limited to a telephone, a tablet, or other suitable electronic device with communication functions.

The Internet 400 can be but not limited to Internet, On-Demand Virtual Leased Line, wireless network including WIFI, Bluetooth or the like, Telephone network including GPRS, CDMA, or the like, Broadcast networks, or the like.

The server 100 can include a storage unit 110 and a processing unit 120. The storage unit 110 can be used to store the database at least including delivery information of each order, and the database can be updated in real time.

The smart device 200 can include a processing unit 210, a storage unit 220, a speeding sensing unit 230, a Global Position System (GPS) unit 240, a timing unit 250 and an input unit 260.

The storage unit 220 can be used to store a predefined time period. The speed sensing unit 230 can be used to sense a real-time speed of the smart device 200. The GPS unit 240 can be used to position the smart device 200 in real time. The timing unit 250 can be used to time a time period. The input unit 260 can be used to generate input signals in response of input operations applied thereon. In at least one embodiment, the input unit 260 can be but not limited to a touch screen, a mechanical keyboard or the like.

The mobile terminal 300 can include a processing unit 310, a storage unit 320 and an input unit 330. The input unit 330 can be used to generate input signals in response of input operations applied thereon. In at least one embodiment, the input unit 330 can be but not limited to a touch screen, a mechanical keyboard or the like.

In at least one embodiment, the storage units 110, 220 and 320 can be an internal storage system, such as a flash memory, a random access memory (RAM) for temporary storage of information, and/or a read- memory (ROM) for permanent storage of information.

In at least one embodiment, the storage units 110, 220 and 320 can also be a storage system, such as a hard disk, a storage card, or a data storage medium. The storage units 110, 220 and 320 can include volatile and/or non-volatile storage devices.

In at least one embodiment, the storage units 110, 220 and 320 can include two or more storage devices such that one storage device is a memory and the other storage device is a hard drive. Additionally, the storage units 110, 220 and 320 can be respectively located either entirely or partially external relative to the server 100, the smart device 200 or the mobile terminal 300.

In at least one embodiment, the processing units 120, 210 and 310 can be a central processing unit, a digital signal processor, or a single chip, for example.

FIG. 2 shows the delivery address positioning system based on Internet of vehicles. The delivery address positioning system 1 can include a number of modules. The number of modules can include a registering module 11, a time controlling module 12, a position information transmitting module 13, a determining module 14, a confirming module 15, a delivery address transmitting module 16 and an information module 17. The registering module 11, the time controlling module 12 and the position information transmitting module 13 can be stored in the storage unit 220 of the smart device 200, and further applied on the processing unit 210 of the smart device 200. The determining module 14, the confirming module 15 and the delivery address transmitting module 16 can be stored in the storage unit 110 of the server 100, and further applied on the processing unit 120 of the server 100. The information module 17 can be stored in the storage unit 320 of the mobile terminal 300, and further applied on the processing unit 310 of the mobile terminal 300. The modules of the delivery address positioning system 1 can include separated functionalities represented by hardware or integrated circuits, or as software and hardware combinations, such as a special-purpose processor or a general-purpose processor with special-purpose firmware.

The registering module 11 can be used to generate a registration request containing registration information in response of input operations applied on the input unit 260 of the smart device 200, and further transmit the registration request to the server 100 via the Internet 400. The server 100 can complete the registration in response of the registration request and further store the registration information contained in the registration request in the storage unit 110 of the server 100. In at least one embodiment, the registration information can be but not limited to a user's name or nickname, a user's contact information, a vehicle's color, a vehicle's type and/or a vehicle's license plate number or the like, and/or a delivery time period that the user desired, or the like. In at least one embodiment, the registration information can be further stored in the storage unit 220 of the smart device 200 synchronously when the input operations are applied to the input unit 260 of the smart device 200 to input the registration information.

The time controlling module 12 can be used to control the timing unit 250 to start timing when the real-time speed of the smart device 200, that is, the real-time speed of the vehicle, sensed by the speed sensing unit 230 is zero. When the timing unit 250 is timing, the time controlling module 12 can be further used to control the timing unit 250 to stop timing when the real-time speed of the smart device 200, that is, the real-time speed of the vehicle, sensed by the speed sensing unit 230 is not zero. Furthermore, when the real-time speed of the smart device 200, that is, the real-time speed of the vehicle, sensed by the speed sensing unit 230 is zero again, the time controlling module 12 can be further used to control the timing unit 250 to start timing from zero.

The position information transmitting module 13 can be used to obtain a position information of the smart device 200 from the GPS unit 240 of the smart device 200 and the registration information stored by the storage unit 220 when the time period timed by the timing unit 250 is greater than the predefined time period stored by the storage unit 220, and further transmit the position information and the registration information to the server 100 via the Internet 400.

The determining module 14 can be used to search the database stored in the storage unit 110 of the server 100 according to the registration information. The determining module 14 can be further used to determine whether the database includes at least one order matches with the registration information, that is, the database includes at least one order of which the name and the contact information match with the name and the contact information of the registration information.

The confirming module 15 can be used to control the server 100 to transmit a short text message to the contact information contained in the registration information to ask the user whether the position information and the registration information are allowed to be transmitted to the logistics center 500 for delivering goods easily when the database includes at least one order matches with the registration information.

The information module 17 can be used to generate another short text message in response of input operations applied on the input unit 330 of the mobile terminal 300. The content of the short text message can be agree to transmit or disagree to transmit. The information module 17 can be further used to transmit the another short text message to the server 100 via the Internet 400.

The delivery address transmitting module 16 can be used to deliver the position information and the registration information to the logistics center 500 via the Internet when the content of the short text message is agree to transmit.

The delivery address transmitting module 16 can be used to not deliver position information and the registration information to the logistics center 500 via the Internet when the content of the short text message is disagree to transmit.

In at least one embodiment, the registration information transmitted to the logistics center 500 can only include the vehicle's color, the vehicle's type and/or the vehicle's license plate number.

In at least one embodiment, only the position information but not the registration information can be transmitted to the logistics center 500.

In at least one embodiment, the confirming module 15 can be omitted, and the delivery address transmitting module 16 can be used to deliver the position information and/or the registration information when the database includes at least one order matches with the registration information, and the delivery address transmitting module 16 can be used to not deliver the position information and/or the registration information when the database includes no order matches with the registration information.

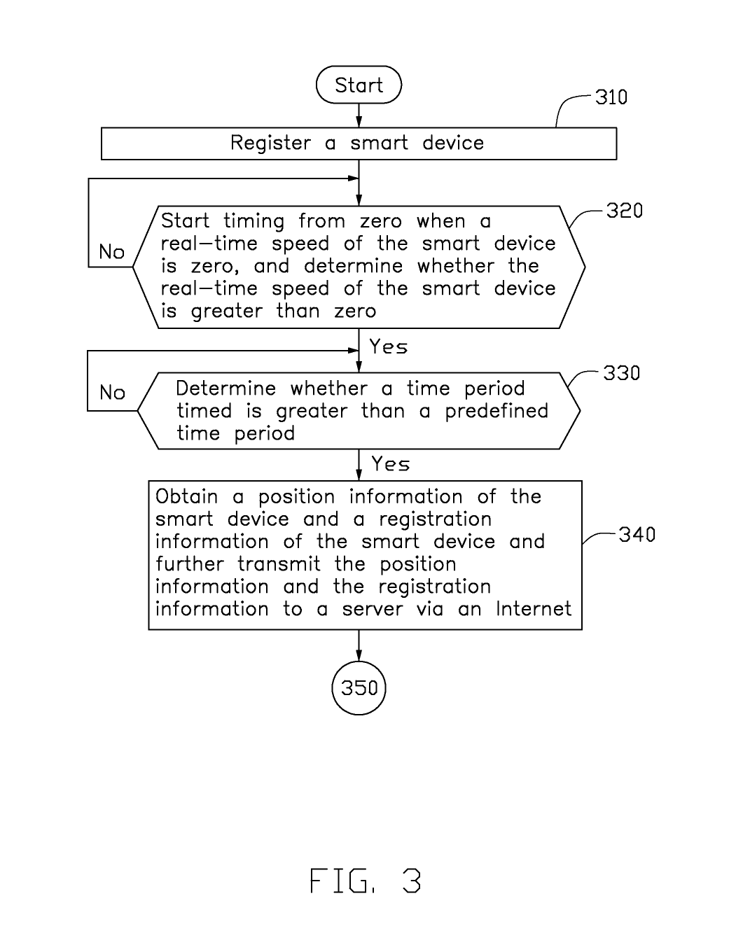

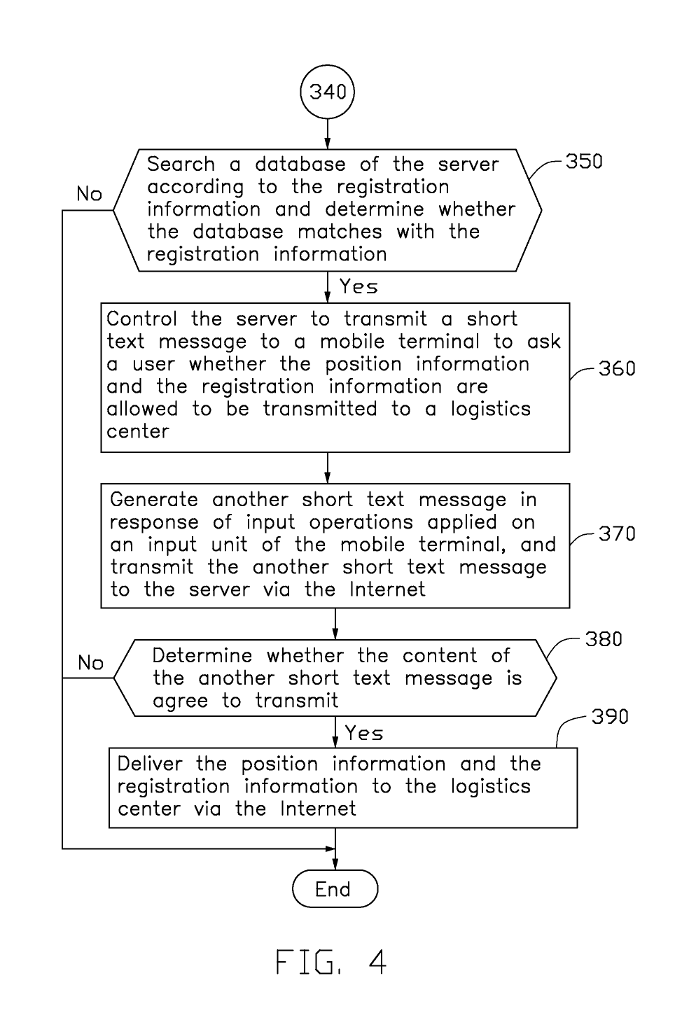

FIGS. 3 and 4 cooperatively illustrate a single flowchart of a delivery address positioning method based on Internet of vehicles. The delivery address positioning method is provided by way of example, as there are a variety of ways to carry out the method. The delivery address positioning method described below can be carried out using the configurations illustrated in FIG. 2, for example, and various elements of these figures are referenced in explaining the example method. Each block shown in FIGS. 3 and 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 310.

At block 310, a registering module generates a registration request containing registration information in response of input operations applied on an input unit of a smart device, and further transmits the registration request to a server via an Internet, the server completes the registration in response of the registration request and further stores the registration information contained in the registration request in a storage unit of the server, and the registration information is further stored in a storage unit of the smart device.

At block 320, a time controlling module controls a timing unit of the smart device to start timing from zero when a real-time speed of the smart device sensed by a speed sensing unit of the smart device is zero, and further determines whether the real-time speed of the smart device is greater than zero, if yes, the process continues to the block 320, otherwise, the process goes to block 330.

At block 330, the time controlling module determines whether a time period timed by the timing unit is greater than a predefined time period stored in the storage unit of the smart device, if yes, the process goes to block 340, otherwise, the process continues to block 330.

At block 340, a position information transmitting module obtains a position information of the smart device from a GPS unit of the smart device and the registration information stored by the storage unit of the smart device and further transmits the position information and the registration information to the server via the Internet.

At block 350, a determining module searches a database stored in the storage unit of the server according to the registration information and determines whether the database includes at least one order matches with the registration information, if yes, the process goes to block 360, otherwise, the process goes to end.

At block 360, a confirming module controls the server to transmit a short text message to a mobile terminal having the contact information contained in the registration information to ask a user whether the position information and the registration information are allowed to be transmitted to a logistics center for delivering goods easily.

At block 370, an information module generates another short text message in response of input operations applied on an input unit of the mobile terminal, and transmits the another short text message to the server via the Internet.

At block 380, a delivery address transmitting module determines whether the content of the another short text message is agree to transmit, if yes, the process goes to block 390, otherwise, the process goes to end.

At block 390, the delivery address transmitting module delivers the position information and the registration information to the logistics center via the Internet.

When the stopping time of the vehicle is greater than the predefined time period such as 30 minutes, the smart device mounted on the vehicle transmits the position to the server, the server can transmit the position and the information regarding the vehicle such as the vehicle's color, type or the lick, to the logistics center which can help the courier to deliver goods quickly. Furthermore, before transmitting the position and the information regarding the vehicle to the logistics center, the server further ask the user if he agrees to transmit, which can protect privacy of the user.

The embodiments shown and described above are only examples. Many details are often found in the art such as the features of delivery address positioning system based on internet of vehicles and delivery address positioning method using same. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A delivery address positioning system based on Internet of vehicles, running on a smart device and a server, the delivery address positioning system comprising:
at least one processing unit; and
a non-transitory computer readable medium coupled to the at least one processing unit and configured to store instructions for execution by the at least one processing unit, the instructions causing the at least one processing unit to:
control a timing unit of the smart device to start timing when a real-time speed of the smart device is zero;
obtain, when a time period timed by the timing unit is greater than a predefined time period, a position information of the smart device from a global positioning system (GPS) unit of the smart device and a registration information stored by a storage unit of the smart device;
transmit the position information and the registration information to the server;
search a database of the server according to the registration information;
determine whether the database includes at least one order matches with the registration information; and
deliver, when the database includes at least one order matches with the registration information, the position information to a logistics center.

2. The delivery address positioning system of claim 1, wherein the instructions causes the at least one processing unit to:
control the server to transmit a short text message to a mobile terminal to ask a user whether the position information is allowed to be transmitted to the logistics center when the database includes at least one order matches with the registration information; and
deliver the position information to the logistics center when another short text message for agreeing to transmit is received.

3. The delivery address positioning system of claim 2, wherein the short text message is further configured to ask the user whether the registration information is allowed to be transmitted to the logistics center or not, and the instructions causes the at least one processing unit to deliver the position information and the registration information to the logistics center when the another short text message for agreeing to transmit is received.

4. The delivery address positioning system of claim 3, wherein the instructions causes the at least one processing unit to not deliver the position information and the registration information to the logistics center when the another short text message for disagreeing to transmit is received.

5. The delivery address positioning system of claim 1, wherein the instructions causes the at least one processing unit to control the timing unit to stop timing when the timing unit is timing and the real-time speed of the smart device is not zero.

6. The delivery address positioning system of claim 5, wherein the instructions causes the at least one processing unit to control the timing unit to start timing from zero when the real-time speed of the smart device is zero again.

7. The delivery address positioning system of claim 1, wherein the registration information comprises a user's name and a user's contact information, the instructions causes the at least one processing unit to determine whether the database comprises at least one order matches with the registration information according to the user's name and the user's contact information.

8. A delivery address positioning method based on Internet of vehicles, running on a smart device and a server, the delivery address positioning method comprising:
controlling a timing unit of the smart device to start timing when a real-time speed of the smart device is zero;
obtaining a position information of the smart device from a GPS unit of the smart device and a registration information stored by a storage unit of the smart device when a time period timed by the timing unit is greater than a predefined time period;
transmitting the position information and the registration information to the server;
searching a database of the server according to the registration information;
determining whether the database includes at least one order matches with the registration information; and
delivering the position information to a logistics center when the database includes at least one order matches with the registration information.

9. The delivery address positioning method of claim 8, before delivering the position information to a logistics center, and after delivering the position information to a logistics center, the delivery address positioning method further comprises:
controlling the server to transmit a short text message to a mobile terminal to ask a user whether the position information is allowed to be transmitted to the logistics center when the database includes at least one order matches with the registration information;
delivering the position information to the logistics center when another short text message for agreeing to transmit is received.

10. The delivery address positioning method of claim 9, wherein the short text message is configured to ask the user whether the registration information is allowed to be transmitted to the logistics center, and the method of delivering the position information to the logistics center when another short text message for agreeing to transmit is received is:
delivering the position information and the registration information to the logistics center when the another short text message for agreeing to transmit is received.

11. The delivery address positioning method of claim 10, wherein the delivery address positioning method further comprises:
not delivering the position information and the registration information to the logistics center when the another short text message for disagreeing to transmit is received.

12. The delivery address positioning method of claim 8, wherein the delivery address positioning method further comprises:
controlling the timing unit to stop timing when the timing unit is timing and the real-time speed of the smart device is not zero.

13. The delivery address positioning method of claim 12, wherein the delivery address positioning method further comprises:
controlling the timing unit to start timing from zero when the real-time speed of the smart device is zero again.

14. The delivery address positioning method of claim 12, wherein the registration information comprises a user's name, and the method of determining whether the database includes at least one order matches with the registration information is:
determining whether the database includes at least one order matches with the registration information according to the user's name and the user's contact information.

15. A non-transitory storage medium having stored thereon instructions that, when executed by at least one processing unit of a smart device and a server, causes the least one processor to execute instructions of a delivery address positioning method, the delivery address positioning method comprising:
controlling a timing unit of the smart device to start timing when a real-time speed of the smart device is zero;
obtaining a position information of the smart device from a GPS unit of the smart device and a registration information stored by a storage unit of the smart device when a time period timed by the timing unit is greater than a predefined time period;
transmitting the position information and the registration information to the server;
searching a database of the server according to the registration information;
determining whether the database includes at least one order matches with the registration information; and
delivering the position information to a logistics center when the database includes at least one order matches with the registration information.

16. The non-transitory storage medium of claim 15, before delivering the position information to a logistics center, and after delivering the position information to a logistics center, the delivery address positioning method further comprises:
controlling the server to transmit a short text message to a mobile terminal to ask a user whether the position information is allowed to be transmitted to the logistics center when the database includes at least one order matches with the registration information;
delivering the position information to the logistics center when another short text message for agreeing to transmit is received.

17. The non-transitory storage medium of claim 16, wherein the short text message is configured to ask the user whether the registration information is allowed to be transmitted to the logistics center, and the method of delivering the position information to the logistics center when another short text message for agreeing to transmit is received is:
delivering the position information and the registration information to the logistics center when the another short text message for agreeing to transmit is received.

18. The non-transitory storage medium of claim 16, wherein the delivery address positioning method further comprises:
not delivering the position information and the registration information to the logistics center when the another short text message for disagreeing to transmit is received.

19. The non-transitory storage medium of claim 15, wherein the delivery address positioning method further comprises:
controlling the timing unit to stop timing when the timing unit is timing and the real-time speed of the smart device is not zero.

20. The non-transitory storage medium of claim 19, wherein the delivery address positioning method further comprises:
controlling the timing unit to start timing from zero when the real-time speed of the smart device is zero again.
